(19) United States
(12) Patent Application Publication
(10) Pub. No.: US 2024/0334942 A1
(43) Pub. Date: Oct. 10, 2024

(54) CEREAL FLOUR BASED DOUGH

(71) Applicant: DSM IP Assets B.V., Heerlen (NL)

(72) Inventors: Paulien Catharina Maria STELTENPOOL, ECHT (NL); Arjen SEIN, ECHT (NL); Cornelis Franciscus VEEKE, Echt (NL)

(21) Appl. No.: 18/718,688

(22) PCT Filed: Dec. 15, 2022
(86) PCT No.: PCT/EP2022/086037

§ 371 Date: Jun. 11, 2024

(30) Foreign Application Priority Data
Dec. 16, 2021 (EP) 21215024.7

(51) Int. Cl. A21D 2/26; A21D 10/00; A21D 13/064; A21D 13/41; A21D 13/42

(52) U.S. Cl. CPC A21D 2/266; A21D 10/005; A21D 13/064; A21D 13/41; A21D 13/42

(57) ABSTRACT

The present invention relates to a cereal flour-based dough comprising at least 50 wt. % cereal flour, based on the dry weight of the cereal flour-based dough, and rapeseed protein, wherein said rapeseed protein is present in an amount between 0.01 and 15 wt. %, based on the weight of the cereal flour in the cereal flour-based dough, wherein the cereal flour has a gluten content of 5-20 wt. %.

### FIELD

The present invention relates to a cereal flour-based dough comprising cereal flour and rapeseed protein. Further, the present invention relates to a method for producing a cereal flour-based dough. Further, the present invention relates to a bread improver composition. Further, the present invention relates to a baked product. Further, the present invention relates to the use of rapeseed protein.

### BACKGROUND

In the baking industry, e.g. in the industrial dough and bread making, ingredients are commonly used to improve properties of a dough and or a baked product. Dough properties that may be improved comprise stability, gas retaining capability, elasticity, extensibility, moldability etcetera. Properties of the baked products that may be improved comprise volume, crust crispiness, oven spring, crumb texture, crumb structure, crumb softness, flavour, relative softness and shelf life.

Depending on the final application and the protein content and quality of the cereal used, increased extensibility of the dough can be desired. For example, to improve dough sheeting, increase diameter or improve loaf volume. Commonly used ingredients to give dough relaxation are L-cysteine, sodium metabisulphite or glutathione, such as BakeZyme® Relax Plus from DSM. However, there is a growing resistance of consumers to chemical ingredients and therefore there is a need for non-chemical alternatives which are more label friendly.

The present inventors addressed this problem by using rapeseed protein to improve dough properties. It has been found that rapeseed protein provides dough extensibility and is suitable to replace dough relaxers such as L-cysteine.

EP1389921 describes a process for forming a food composition wherein a canola protein isolate is provided. Disclosed are all kind of protein functionalities such as foaming, film forming, water binding, cohesion, thickening, gelation, elasticity, emulsification, fat binding or fiber forming functionality. The protein isolate is incorporated in a food composition in substitution for egg white, milk protein, whole egg, meat fibers, or gelatin.

### DETAILED DESCRIPTION

The present invention relates to a cereal flour-based dough comprising cereal flour and/or rapeseed protein (isolate), wherein said rapeseed protein (isolate) is present in an amount between 0.01 and 15 wt. %, based on the weight of the cereal flour in the cereal flour-based dough.

The present invention relates to a cereal flour-based dough comprising at least 50 wt. % cereal flour, based on the dry weight of the cereal flour-based dough, and rapeseed protein, wherein said rapeseed protein is present in an amount between 0.01 and 15 wt. %, based on the weight of the cereal flour in the cereal flour-based dough, wherein the cereal flour has a gluten content of 5-20 wt. %.

Surprisingly, the present inventors found that addition of rapeseed protein to a cereal flour-based dough improves the extensibility of the dough and volume of the baked product

The term “dough” is defined herein as a mixture of flour, water and optionally other ingredients. Usually, dough is firm enough to knead or roll. The dough may be fresh, frozen, prepared or parbaked. Dough is usually made from basic dough ingredients including (cereal) flour, such as wheat flour, water and optionally salt. For leavened products, primarily baker's yeast is used, and optionally chemical leavening compounds can be used, such as a combination of an acid (generating compound) and bicarbonate.

The term ‘based on the weight of the cereal flour in the cereal flour-based dough’ means that the amounts indicated as such are expressed as weight percentages of the weight of the cereal flour. For example, if the amount of cereal flour in a cereal flour-based dough is 3000 gram, 0.01 wt. %, based on the weight of the cereal flour in the cereal flour-based dough, means 0.0001*3000 gram is 0.3 gram, and 5 wt. % means 0.05*3000 gram is 150 gram.

Alternatively, the present invention relates to a cereal flour-based dough comprising cereal flour and rapeseed protein, wherein said rapeseed protein is present in an amount between 0.01 and 5 wt. %, based on the flour weight (in the cereal flour-based dough).

Preferably, the amount of rapeseed protein is determined as follows:
using LC-MS/MS-based quantification of rapeseed proteins in bread dough is based on a published report about the quantification of proteins from oilseed species, including rapeseed, in meat products (Sporl, J., K. Speer and W. Jira (2022). “Simultaneous Mass Spectrometric Detection of Proteins of Ten Oilseed Species in Meat Products.” Foods 11(14)). In a nutshell, proteins are extracted from the food matrix, then reduced, alkylated, and trypsin-digested. Relevant marker peptides for rapeseed are selected and used for quantification, using standard doughs as external calibrators.

The bread dough samples to analyze, as well as the standard doughs containing known amounts of rapeseed proteins over the relevant quantification range, are first freeze-dried to remove water, and ground to a homogenous powder.

1.0 g of this powder is accurately weighed and 100 mM ammonium bicarbonate buffer, pH 8.0, 300 mM NaCl is added to a final volume of 10.0 mL in a volumetric flask. The suspension is left for 1 hour at ambient temperature with stirring to allow protein solubilization. After centrifugation of 1 mL of the suspension (10 min, 25° C., 20817 rcf), the proteins in the supernatant fraction are reduced with dithiothreitol, alkylated with iodoacetamide and digested to peptides with trypsin, before addition of formic acid to stop the digestion. Alternative sample preparation may be considered, provided it is demonstrated to be at least as good as the one described above, in terms of extraction of rapeseed proteins and/or removal of matrix interferences.

Peptides are then separated by C18 reversed-phase liquid chromatography with a gradient of acetonitrile in water, containing 0.1% formic acid, and followed by mass-spectrometry detection. Quantification of rapeseed proteins is based on peak intensity of marker peptides. Sporl et al. reports the choice of two peptides as quantification markers for rapeseed:
QQQGQQGQQLQQVISR, which is found for instance in the homologous proteins Brassica napus napin (Uniprot entry P17333) and napin-3 (Uniprot entry P80208), in both cases following an arginyl residue in their amino acid sequence.
NLRPFLIAGNNPQGQQWLQGR, which is found in a Brassica rapa pekinensis (Chinese cabage) protein (Uniprot entry M4DFK2), but shares only 95% identity with the closest Brassica napus sequenced cruciferin protein (cruciferin CRU4, Uniprot entry P33522) according to a BLAST search (search done on Dec. 9, 2022, against the UniprotKB reference proteomes+Swissprot databases, restricted to Brassica taxonomy). However the difference between those two peptides is only due to a Leucyl vs. Isoleucyl residue at the 7th amino acid position. These residues have the same mass and while NLRPFLIAGNNPQGQQWLQGR and NLRPFLLAGNNPQGQQWLQGR do not have the same retention time in RPLC, they are isobaric and produce the same MS and MS/MS spectra. Sporl et al. mentioned that while NLRPFLLAGNNPQGQQWLQGR is found in different Brassica species, as well as Sinapis alba, NLRPFLIAGNNPQGQQWLQGR is unique for Brassica napus This does not matter in the case of quantifying rapeseed in dough, since addition of plant material from related Brassica species such as mustard is a concern with respect to method specificity in meat products, but not in bread dough. It should be investigated whether, for the bread dough matrix analyzed and the mass spectrometry equipment used, the peptides suggested by Sporl et al. are the most sensible choice. Also, monitoring more peptides (at least three peptides for each cruciferin and napin protein groups) would be preferrable for more reliable quantification. Peptides should be selected based on their mass spectrometry intensity, but also their reliability: no miscleavage allowed, and preferably containing neither a cysteinyl residue, nor other residues susceptible of post-translational modifications (to the extent that this is possible: napin in particular contains many asparaginyl and glutaminyl residues that can undergo deamidation).

Rapeseed protein isolates mainly comprise napin and cruciferin proteins, but the ratio between these proteins can vary between isolates. To address this, cruciferins and napins should be quantified individually based on the sum of the peak intensity of their respective marker peptides, and the total protein content considered as the sum of both protein group abundances. The absolute amounts of cruciferins and napins in the rapeseed protein isolate used to prepare the standard doughs are determined by size exclusion chromatography (SEC) using the following test: 10 mg sample of sample is accurately weighed in a 10-mL volumetric flask, and 500 mM NaCl saline solution is added up to 10 mL. The suspension is left for 1 hour at ambient temperature with stirring to allow protein solubilization. After centrifugation of 1 mL of the suspension (10 min, 25° C., 20817 rcf, the supernatant is analyzed by High-Performance SEC using 500 mM NaCl saline solution as mobile phase, followed by detection using UV absorbance at 220 nm, wherein the relative contribution of cruciferin and napin (wt. %) is calculated as the ratio of the peak area of each protein with respect to the sum of both peak areas, and absolute quantitation of cruciferin and napin is calculated using the response factor determined with a bovine serum albumin protein solution as an external calibration standard.

In a preferred embodiment, said rapeseed protein is present in an amount between 0.05 and 5, 0.1 and 4, between 0.2 to 3.5 or between 0.3 to 3 wt. %, based on the weight of the cereal flour in the cereal flour-based dough. The inventors identified that these small amounts of rapeseed protein increase dough extensibility and can replace known dough relaxers such as L-cysteine.

In a preferred embodiment, the present cereal flour-based dough comprises at least 50 wt. % cereal flour, based on the dry weight of the cereal flour-based dough. To avoid any confusion, the term ‘based on the dry weight of the cereal flour-based dough’ relates to the total dry weight of the cereal flour-based dough including any other ingredients that might be present and are expressed as wt. %, based on the weight of the cereal flour in the cereal flour-based dough.

Preferably, the present cereal flour-based dough comprises at least 55, 60, 65, 70, 75, 80, 85, 90, 95, or at least 99 wt. % cereal flour, based on the dry weight of the cereal flour-based dough.

Preferably, the present cereal flour-based dough comprises 55 to 98, 60 to 98, 65 to 98, 70 to 97, 75 to 96 or 80 to 95 wt. % cereal flour, based on the dry weight of the cereal flour-based dough.

Alternatively, the present cereal flour-based dough comprises at least 50 wt. % cereal flour, based on the weight of cereal flour-based dough. To avoid any confusion, the term ‘based on the weight of the cereal flour-based dough’ relates to the total weight of the cereal flour-based dough including any other ingredients that might be present and are expressed as wt. %, based on the weight of the cereal flour in the cereal flour-based dough. Preferably, the present cereal flour-based dough comprises at least 55, 60, 65, 70, 75, 80, 85, 90, 95, or at least 99 wt. % cereal flour, based on the weight of the cereal flour-based dough. Preferably, the present cereal flour-based dough comprises 55 to 98, 60 to 98, 65 to 98, 70 to 97, 75 to 96 or 80 to 95 wt. % cereal flour, based on the weight of the cereal flour-based dough.

In an embodiment, the present cereal flour-based dough comprises yeast, sodium bicarbonate and/or salt. Preferably the yeast is active yeast. Preferably the amount of yeast is within the range of 0.1 to 5, 0.5 to 4, or 1 to 3 wt. %, based on the weight of the cereal flour in the cereal flour-based dough. Preferably the amount of salt is within the range of 0.1 to 5, 0.5 to 4, or 1 to 3 wt. %, based on the weight of the cereal flour weight in the cereal flour-based dough.

In a preferred embodiment, the present cereal is chosen from the group consisting of corn, rice, wheat, barley, sorghum, millet, oats, rye, triticale, buck wheat, quinoa, spelt, einkorn, emmer, durum and kamut. Preferably the present cereal is wheat. And thus, preferably the present cereal flour-based dough is a wheat flour-based dough.

In an embodiment, the present cereal flour-based dough further comprises water, preferably in an amount between 20 to 75 wt. % based on the weight of the cereal flour in the cereal flour-based dough. Preferably the amount of water is within the range of 25 to 70, 30 to 65, 25 to 45, 30 to 40, 40 to 70, 45 to 65 or 50 to 60 wt. % based on the weight of the cereal flour in the cereal flour-based dough.

In an embodiment, the present cereal flour-based dough further comprises a bread improver, preferably in an amount of between 0.1 to 5 wt. % based on the weight of the cereal flour in the cereal flour-based dough. Preferably the bread improver comprises enzymes, emulsifiers, ascorbic acid and/or flour.

In an embodiment, the present cereal flour has a gluten content of 9 to 16 wt. %, preferably 13 to 16 wt. %, of the cereal flour. For example, a wheat flour having 5-20 wt. %, preferably 9 to 16 wt. %, preferably 13 to 16 wt. % gluten or 14 to 16 wt. % gluten. It is particularly advantageous that rapeseed protein can be used as a dough relaxer with high amounts of gluten.

In an embodiment, the present cereal dough is a bread dough, tortilla dough, pizza dough, chapati dough, pita dough, Iafa dough, lavash dough, matzah dough, naan dough, roti dough, sangarak dough, cracker dough, wafer dough, pastry dough, croissant dough, brioche dough, panettone dough, pasta dough, noodles dough, taco dough, cookie dough, bagel dough, pie crust dough, steam bread dough, brownie batter or sheet cake batter.

The rapeseed used to obtain the rapeseed protein as applied in the instant invention is usually of the varieties Brassica napus or Brassica juncea. These varieties contain low levels of erucic acid and glucosinolates, and are the source of canola, a generic term for rapeseed oil comprising less than 2% erucic acid and less than 30 mmol/g glucosinolates. The predominant storage proteins found in rapeseed are cruciferins and napins. Cruciferins are globulins and are the major storage protein in the seed. A cruciferin is composed of 6 subunits and has a total molecular weight of approximately 300 kDa. Napins are albumins and are low molecular weight storage proteins with a molecular weight of approximately 14 kDa. Another protein that may be present is oleosin, usually present in less than 1 wt. % of the rapeseed protein (isolate). Napins are easily solubilized and are primarily proposed for use in applications where solubility is key. Preferably the present rapeseed protein is a rapeseed protein isolate.

In a preferred embodiment, the present rapeseed protein (isolate) comprises 40 to 65 wt. % cruciferins and 35 to 60 wt. % napins (of the rapeseed protein). Preferably, the present rapeseed protein comprises 40 to 55 wt. % cruciferins and 45 to 60 wt. % napins.

In a preferred embodiment, the present rapeseed protein (isolate) comprises 60 to 95 wt. % cruciferins and 5 to 40 wt. % napins, or 85 to 90 wt. % cruciferins and 5 to 15 wt. % napins or 60 to 80 wt. % cruciferins and 20 to 40 wt. % napins. Preferably, the present rapeseed protein comprises 65 to 75 wt. % cruciferins and 25 to 35 wt. % napins.

In a preferred embodiment, the present rapeseed protein (isolate) (not) comprises 0 to 20 wt. % cruciferins and 80 to 100 wt. % napins. Preferably, the present rapeseed protein (does not) comprises 0 to 10 wt. % cruciferins and 90 to 100 wt. % napins. Preferably, the present rapeseed protein (does not) comprises 1 to 5 wt. % cruciferins and 95 to 100 wt. % napins. Preferably, the present rapeseed protein (does not) comprises 1 to 15 wt. % cruciferins and 85 to 100 wt. % napins.

Preferably, the amounts of cruciferins and napins calculated based on the total amount of protein in the present cake mix. Or alternatively, the amounts of cruciferins and napins are calcuated based on the sum of cruciferins and napins present in the cake mix. Preferably, the amounts of cruciderins and napins are determined by size exclusion chromatography (SEC). Preferably, the amounts of cruciderins and napins are determined by size exclusion chromatography (SEC) using the following test:
samples of protein isolate are dissolved in a 500 mM NaCl saline solution and analyzed by High Performance SEC using the same solution as the mobile phase, followed by detection using measuring UV absorbance at 280 nm, wherein the relative contribution of cruciferin and napin (wt. %) was calculated as the ratio of the peak area of each protein with respect to the sum of both peak areas.

Preferably, the present rapeseed protein (isolate) comprises 40 to 65 wt. % 12S and 35 to 60 wt. % 2S. Preferably, the present rapeseed protein comprises 40 to 55 wt. % 12S and 45 to 60 wt. % 2S.

In a preferred embodiment, the present rapeseed protein (isolate) comprises 60 to 80 wt. % 12S and 20 to 40 wt. % 2S. Preferably, the present rapeseed protein comprises 65 to 75 wt. % 12S and 25 to 35 wt. % 2S. Preferably, the present rapeseed protein comprises 40 to 65 wt. % 12S and 20 to 40 wt. % 2S.

In a preferred embodiment, the present rapeseed protein (isolate) (does not) comprises 0 to 20 wt. % 12S and 80 to 100 wt. % 2S. Preferably, the present rapeseed protein (does not) comprises 0 to 10 wt. % 12S and 90 to 100 wt. % 2S. Preferably, the present rapeseed protein (does not) comprises 1 to 5 wt. % 12S and 95 to 100 wt. % 2S.

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test: samples of protein isolate are dissolved in a 3.0% (or 500 mM) NaCl saline solution and amounts determined using interference optics.

In a preferred embodiment, the present rapeseed protein (isolate) comprises a conductivity in a 2 wt. % aqueous solution of less than 9000 μS/cm over a pH range of 2 to 12. More preferably the conductivity of the native rapeseed protein isolate in a 2 wt. % aqueous solution is less than 4000 μS/cm over a pH range of 2.5 to 11.5. For comparison the conductivity of a 5 g/I NaCl aqueous solution is around 9400 μS/cm. Preferably conductivity is measured with a conductivity meter, for example Hach sensION+EC71.

In a preferred embodiment, the present rapeseed protein (isolate) comprises a solubility of at least 88% when measured over a pH range from 3 to 10 at a temperature of 23+/−2° C. Preferably a solubility of at least 90, 91, 92, 93, 94, 95, 96, 97, 98 or at least 99% over a pH range from 3 to 10 at a temperature of 23+/−2° C. This is also known as the soluble solids index (SSI).

Preferably, solubility is calculated by:

Protein solubility (%)=(concentration of protein in supernatant (in g/l)/concentration of protein in total dispersion (in g/l))×100.

Preferably, the solubility is measured using the following test:
sufficient protein to supply 0.8 g of protein is weighed into a beaker;
a small amount of demineralized water is added to the powder and the mixture is stirred until a smooth paste is formed;
additional demineralized water is then added to make a total weight of 40 g (yielding a 2% w/w protein dispersion);
the dispersion is slowly stirred for at least 30 min using a magnetic stirrer;
afterwards the pH is determined and adjusted to the desired level (2, 3, 4, etc.) with NaOH or HCl;
the pH of the dispersion is measured and corrected periodically during 60 minutes stirring;
after 60 minutes of stirring, an aliquot of the protein dispersion is reserved for protein concentration determination (Dumas analysis; Dumas N×6.25), another portion of the sample is centrifuged at 20,000 G for 2 min;
the supernatant and pellet are separated after centrifugation;
the protein concentration of the supernatant is also determined by Dumas analysis (Dumas N×6.25);
and protein solubility is calculated by:

Protein solubility (%)=(concentration of protein in supernatant (in g/l)/concentration of protein in total dispersion (in g/l))×100.

For use in human food consumption the removal of phytates, phenolics (or polyphenolics) and glucosinolates prevents unattractive flavour and coloration and prevents decreased nutritional value of the protein isolate. At the same time this removal enhances the protein content of the protein isolate.

In a preferred embodiment, the present rapeseed protein (isolate) has a phytate level less than 5 wt. %, preferably less than, 4, 3, 2, 1, 0.5, 0.4, 0.3, 0.2. 0.1 or less than 0.01 wt. %. Alternatively, the present rapeseed protein (isolate) has a phytate level of 0.01 to 4, 0.05 to 3, 0.1 to 1 wt. %. Preferably the phytate level is measured using method QD495, based on Ellis et al, Analytical Biochemistry Vol. 77:536-539 (1977).

In a preferred embodiment, the present rapeseed protein (isolate) has a phenolic content of less than 1 wt. % on dry matter expressed as sinapic acid equivalents. Preferably less than 0.9, 0.8, 0.7, 0.6, 0.5, 0.4, 0.3, 0.2, 0.1, 0.05 or less than 0.01 wt. % on dry matter expressed as sinapic acid equivalents.

In a preferred embodiment, the present rapeseed protein is a rapeseed protein isolate. The term isolate means that on a dry basis, 85 wt. % of the total weight of the isolate is protein. This is calculated using the Dumas method according to AOAC Official Method 991.20 Nitrogen (Total) in Milk, using a conversion factor of 6.25 was used to determine the amount of protein (% (w/w)). Typically, the non-protein content of the protein isolate includes non-protein compounds such as, fibre and/or other carbohydrates, minerals, anti-nutritional substances. Preferably the present protein isolate has a protein content of at least 90 wt. % (calculated as Dumas N×6.25) on a dry weight basis, preferably at least 91, 92, 93, 94, 95, 96, 97, 98, or at least 99 wt. % on a dry weight basis (calculated as Dumas N×6.25).

According to another aspect, the present invention relates to a method for producing a cereal flour-based dough as defined herein, comprising blending water, a cereal flour and rapeseed protein (isolate) to form the cereal-flour based dough.

The cereal flour and rapeseed protein are preferably blended first, after which water can be added to prepare the dough. Alternatively, the rapeseed protein can be dissolved in water, whereafter the solution is added to the cereal flour—optionally preblended with other components—to prepare the dough.

Preferably, the present method further comprises a step of baking the dough. Preferably baking the dough to provide a baked product.

According to an aspect, the present invention relates to a bread improver composition comprising from 1 to 80 wt. % rapeseed protein (isolate) and a compound selected from an enzyme, an emulsifier, ascorbic acid and flour. The bread improver can be in any form, such as a powder or a liquid. A bread improver composition is suitable to be used as ingredient in dough, preferably bread dough, for improving characteristics of the dough and/or bread.

According to another aspect the present invention relates to a baked product comprising at least 50 wt. % cereal flour and 0.01 and 15 wt. % rapeseed protein (isolate), based on the (dry) weight of the baked product. The advantage of the baked products according to the invention is that an increased volume of the baked product is provided. Hence, preferably the present baked product has a larger volume than a comparable baked product produced without rapeseed protein, or product with L-cysteine. Preferably, the rapeseed protein is as further defined herein.

Preferably, the present baked product is chosen from bread (such as tin bread or batards) buns, tortilla, pizza, chapati, pita, lafa, lavash, matzah, naan, roti, sangarak, cracker, wafer, pastry, croissant, brioche, panettone, pasta, noodles, taco, cake, pancake, cookie, bagel, pie crust, brownie, steam bread or sheet cake.

The term ‘baked product’ refers to a baked food product prepared from a dough. Baked products are typically made by baking a dough at a suitable temperature for making the baked product such as a temperature between 100° C. and 300° C.

Preferably, the present baked product comprises between 0.05 and 5, between 0.1 and 4, between 0.2 to 3.5 or between 0.3 to 3 wt. % rapeseed protein, based on the (dry) weight of the baked product.

According to another aspect, the present invention relates to the use of use of rapeseed protein (isolate) as a cereal flour-based dough relaxation aid (or dough relaxer), or the use as a relaxation aid in cereal-based doughs. Or the use of rapeseed protein (isolate) for increasing the volume of a baked product. Or to the use of rapeseed protein (isolate) for improving cereal flour-based dough extensibility.

Preferably wherein the cereal flour-based dough comprises a cereal chosen from the group consisting of corn, rice, wheat, barley, sorghum, millet, oats, rye, triticale, buckwheat, quinoa, spelt, einkorn, emmer, durum and kamut. Preferably wherein the cereal flour is a wheat flour, preferably a wheat flour chosen from the group consisting of white flour, whole wheat flour, Graham flour, instant flour, whole wheat white flour, all-purpose flour and enriched flour.

Preferably wherein the dough is a bread dough, tortilla dough, pizza dough, chapati dough, pita dough, lafa dough, lavash dough, matzah dough, naan dough, roti dough, sangarak dough, cracker dough, wafer dough, pastry dough, croissant dough, brioche dough, panettone dough, pasta dough, noodles dough, taco dough, cookie dough, bagel dough, pie crust dough, steam bread dough, brownie batter or sheet cake batter.

Preferably wherein the baked product is chosen from from bread (such as tin bread or batards) buns, tortilla, pizza, chapati, pita, lafa, lavash, matzah, naan, roti, sangarak, cracker, wafer, pastry, croissant, brioche, panettone, pasta, noodles, taco, cake, pancake, cookie, bagel, pie crust, brownie, steam bread or sheet cake. Preferably wherein the baked product is chosen from white bread, whole meal bread, tortilla or pizza.

Preferably, the present rapeseed protein (isolate) comprises 40 to 65 wt. % 12S and 35 to 60 wt. % 2S. Preferably, the present rapeseed protein comprises 40 to 55 wt. % 12S and 45 to 60 wt. % 2S.

In a preferred embodiment, the present rapeseed protein (isolate) comprises 60 to 80 wt. % 12S and 20 to 40 wt. % 2S. Preferably, the present rapeseed protein comprises 65 to 75 wt. % 12S and 25 to 35 wt. % 2S.

In a preferred embodiment, the present rapeseed protein (isolate) comprises 0 to 10 wt. % 12S and 90 to 110 wt. % 2S. Preferably, the present rapeseed protein comprises 1 to 5 wt. % 12S and 95 to 100 wt. % 2S.

The invention is further illustrated in the following examples, wherein reference is made to the figures showing spider graphs of tested dough properties.

### Example 1

### Preparation of White Tin Breads

Doughs were prepared using the ingredients of table 1. In the tables the % OFW is the weight percentage Of Flour Weight, thus per weight of the cereal flour in the cereal flour-based dough.

TABLE 1
White Tin Bread dough composition

| Ingredient | grams | % OFW | Type |
|---|---|---|---|
| Wheat flour | 2400 | | Kolibri (11.5% protein on dry matter), |
| | | | Dossche Mills, the Netherlands |
| Wheat flour | 600 | | Ibis (15% protein on dry matter), |
| | | | Dossche Mills, the Netherlands |
| Water | 1770 | 59 | Tapwater |
| Salt | 48 | 1.6 | Suprasel, Akzo Nobel, |
| | | | the Netherlands |
| Yeast | 72 | 2.4 | Koningsgist, AB Mauri, |
| | | | the Netherlands |
| Flour corrector 1 | 15 | 0.5 | Custom mix (see below) |

Flour corrector 1 was a composition comprising 20 ppm ascorbic acid (from DSM Nutritional Products, Switzerland), 5 ppm Bakezyme® P500 (fungal alpha-amylase from DSM, The Netherlands), 15 ppm Bakezyme® HSP6000 (fungal hemicellulase from DSM, The Netherlands) and Kolibri flour (from Dossche Mills, the Netherlands) as carrier material.

Relaxation ingredients (or dough relaxers) were added to the dough as displayed in table 2, and the base dough composition (table 1) was adjusted for the amount of water to correct for the dough consistency changed by the addition of the ingredients.

The dough was made in a Diosna SP-12 kneader with settings 1^{st} speed 400 revolutions, 2^{nd} speed 1540 revolutions and had a dough temperature of 27° C. (+/−0.5° C.). The dough was assessed on viscoelastic properties. Then the dough was divided in pieces of 840 g, rounded and proofed in the bench proof cabinet for 45 minutes at 28° C. and 90% relative humidity. Then, the dough pieces were moulded using a Glimek moulder and placed in greased baking tins and assessed on viscoelastic properties. After that, the dough pieces were proofed in a Wachtel Octopus proof cabinet for 75 minutes at 35° C. with a relative humidity of 88%. The fully proofed dough pieces were placed in a Wachtel Piccolo deck oven set at 270° C. top heat and 280° C. floor heat with initial steam addition and baked for 20 minutes. After that, the temperature was decreased to 250° C. top heat and 260° C. floor heat for another 15 minutes.

After baking, the oven was unloaded, the breads were taken out of the baking tins and placed on a rack to cool for at least one hour at ambient temperature, which was typically between 2° and 25° C. After 1-2 hours cooling, the breads were assessed on volume, shape, softness and structure.

After cooling down to room temperature, the volumes of the loaves were determined by an automated bread volume analyser (BVM-LC, TexVol Instruments). The loaf volume of the control bread is defined as 100%. Results are shown in Table 3, which shows the average value of two loaves for each recipe. The control refers to a loaf of bread prepared from the ingredients in Table 1, i.e. to which no dough relaxer was added.

### Results

To test the effect of rapeseed protein on dough characteristics of doughs of table 1, tests 1 to 12 of table 2 are carried out. Doughs 1, 7 and 12 are controls. RPI is the abbreviation of Rapeseed Protein Isolate and was produced according to WO2018/007492 having more than 90 wt. % protein. The amounts in the table are expressed in percentages of flour weight.

TABLE 2
Added relaxation ingredients and applied water correction (% OFW)

| | | | | | | | | | | | | |
|---|---|---|---|---|---|---|---|---|---|---|---|---|
| Ingredient | 1 | 2 | 3 | 4 | 5 | 6 | 7 | 8 | 9 | 10 | 11 | 12 |

| | | | | | | | | | | |
|---|---|---|---|---|---|---|---|---|---|---|
| RPI | 0.3 | 1.5 | 3 | 1.5 | | | | | | 1.5 |
| Glutathione, | | | | | 0.12 | | | | | |
| BakeZyme ® | | | | | | | | | | |
| Relax Plus, | | | | | | | | | | |
| DSM | | | | | | | | | | |
| L-cysteine, | | | | | | | 0.001 | | | |
| Merck, VWR | | | | | | | | | | |
| Pea protein, | | | | | | | | | 1.5 | |
| DMPP80 | | | | | | | | | | |
| Plus, | | | | | | | | | | |
| JianYuan | | | | | | | | | | |
| Solanic 200, | | | | | | | | 1.5 | | |
| Avebe | | | | | | | | | | |
| Water | −2.3 | −4.8 | −2.3 | | | −0.3 | +5 | +8 | −2.3 | |
| correction | | | | | | | | | | |

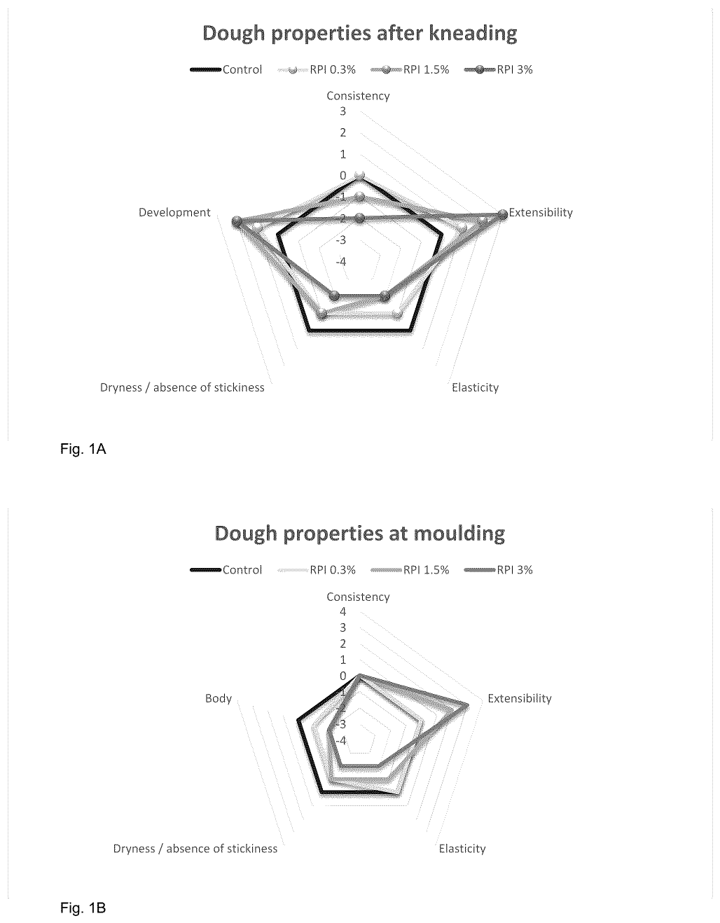

Twelve doughs as shown in table 2 were kneaded and assessed for viscoelastic properties after kneading and at moulding by manual and visual scores by experienced bakers. The results are shown in FIG. 1. When scored −1/+1 it's only noticeable difference in a simultaneous test, −2/+2 is noticeable in daily practice, −3/+3 is clearly noticeable and −4/+4 is very clearly noticeable.

FIG. 1A shows a dose response of RPI illustrating that rapeseed protein isolate increased extensibility, development and stickiness and gave less consistency and elasticity compared to the control after kneading. FIG. 1B shows that at moulding, rapeseed protein isolate increased extensibility, stickiness and decreases elasticity and body compared to the control.

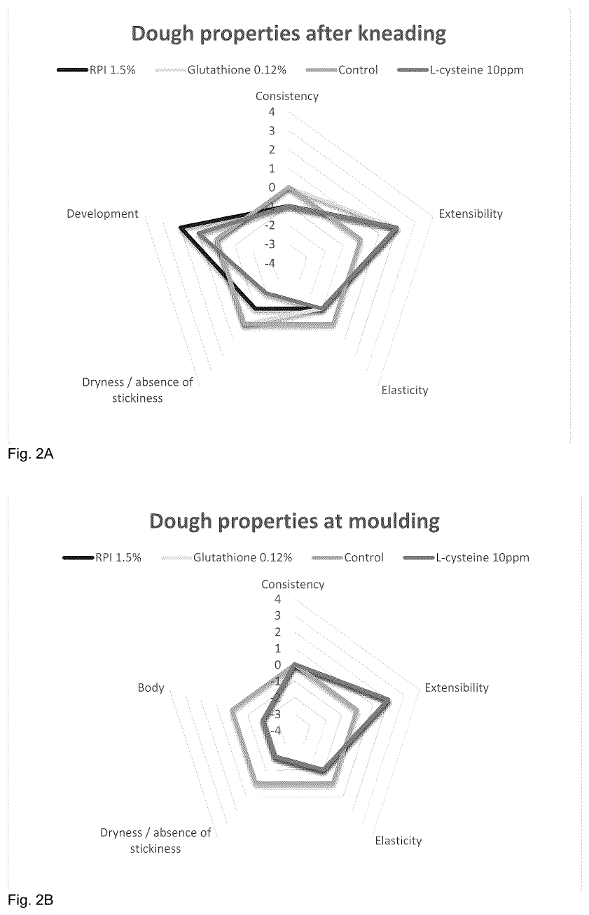

FIG. 2A shows a comparison between RPI, glutathione, L-cysteine and a control, illustrating a similar extensibility and elasticity as glutathione and L-cysteine and RPI gave some extra development compared to glutathione and L-cysteine after kneading. FIG. 2B shows that at moulding of the dough RPI gave similar dough properties as L-cysteine and glutathione.

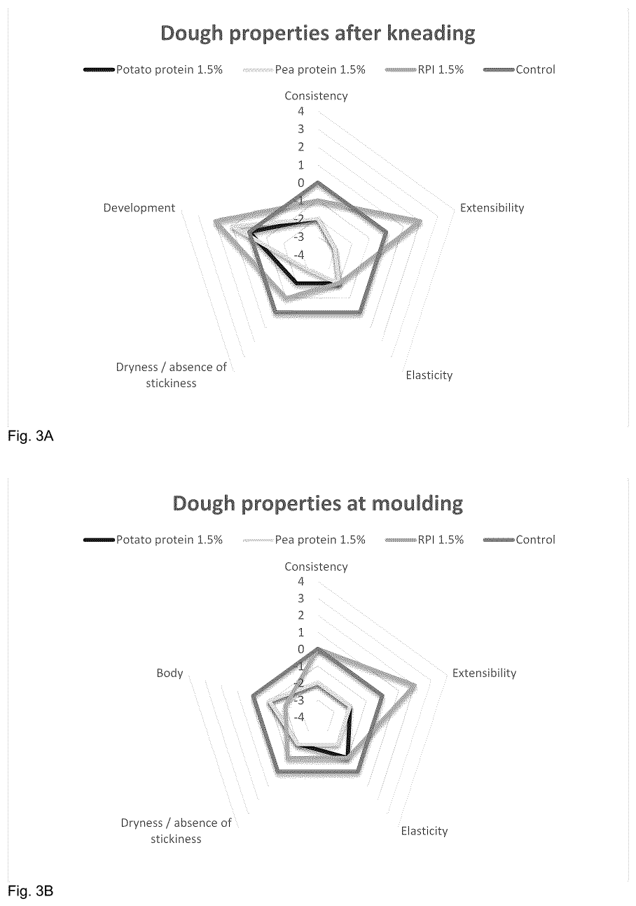

FIG. 3 shows the effect of potato and pea protein on the dough compared to RPI and control. FIG. 3A shows that potato and pea protein did not give an extensible dough after mixing and FIG. 3B shows that potato and pea protein did not give an extensible dough at moulding.

Table 3 shows that potato protein and pea protein gave a significant smaller loaf volume after baking, whereas rapeseed protein isolate gave a slightly increased volume similar to the increased volume obtained by using glutathione and L-cysteine. The numbers are the average of two loaves.

TABLE 3
Relative loaf volumes white tin breads

| Relaxation | |
|---|---|
| ingredient used | Relative |
| (% OFW) | Volume (%) |
| Control | 100 |
| RPI 1.5% | 103 |
| Glutathione 0.12% | 103 |
| L-cysteine 0.001 | 103 |
| Pea protein 1.5% | 85 |
| Potato protein 1.5% | 73 |

### Example 2

### Preparation of Whole Meal Bread

Doughs were prepared using the ingredients of table 4.

TABLE 4
Whole Meal Bread dough composition

| | | % on flour | |
|---|---|---|---|
| Ingredient | grams | weight | Type |
| Whole wheat flour | 3000 | | Acacia (14.5% protein |
| | | | on dry matter), Dossche |
| | | | Mills, the Netherlands |
| Water | 2010 | 67 | Tapwater |
| Salt | 48 | 1.6 | Suprasel, Akzo Nobel, |
| | | | the Netherlands |
| Yeast (Koningsgist) | 72 | 2.4 | Koningsgist, AB Mauri, |
| | | | the Netherlands |
| Flour corrector 1 | 15 | 0.5 | Custom blend (see below) |
| Flour corrector 2 | 90 | 3.0 | Custom blend (see below) |
| DATEM | 12 | 0.4 | Lametop 500, BASF, |
| | | | Germany |

Flour corrector 1 was similar to the one described in example 1. Flour corrector 2 was a composition comprising 1% whey powder (from Vreugdenhil Dairy Foods, the Netherlands), 1% dextrose (from Tereos Syral, Belgium), 1% vital wheat gluten (from Tereos Syral, Belgium) and Kolibri flour (from Dossche Mills, the Netherlands) as carrier material.

The dough was made in a Diosna SP-12 kneader with settings 1^{st} speed 400 revolutions, 2^{nd} speed 2040 revolutions and had a dough temperature of 26° C. (+/−0.5° C.). The dough was assessed on viscoelastic properties. Then the dough was divided in pieces of 940 g, rounded and proofed in the bench proof cabinet for 40 minutes at 28° C. and 90% relative humidity. Then, the dough pieces were moulded using a Glimek moulder and placed in greased baking tins and assessed on viscoelastic properties. After that, the dough pieces were proofed in a Wachtel Octopus proof cabinet for 75 minutes at 35° C. with a relative humidity of 88%. The fully proofed dough pieces were placed in a Wachtel Piccolo deck oven set at 280° C. top heat and 280° C. floor heat with initial steam addition and baked for 5 minutes. After that, the temperature was decreased to 250° C. top heat and 250° C. floor heat for another 25 minutes. And after that, the temperature was decreased to 220° C. top heat and 220° C. floor heat for another 15 minutes.

After baking, the oven was unloaded, the breads were taken out of the baking tins and placed on a rack to cool for at least one hour at ambient temperature, which was typically between 2° and 25° C. After 1-2 hours cooling, the breads were assessed on volume, shape, softness and structure.

After cooling down to room temperature, the volumes of the loaves were determined by an automated bread volume analyser (BVM-LC, TexVol Instruments). The loaf volume of the control bread is defined as 100%. Results are shown in Table 6, which shows the average value of two loaves for each recipe. The control refers to a loaf of bread prepared from the ingredients in Table 4, i.e. to which no dough relaxer was added.

### Results

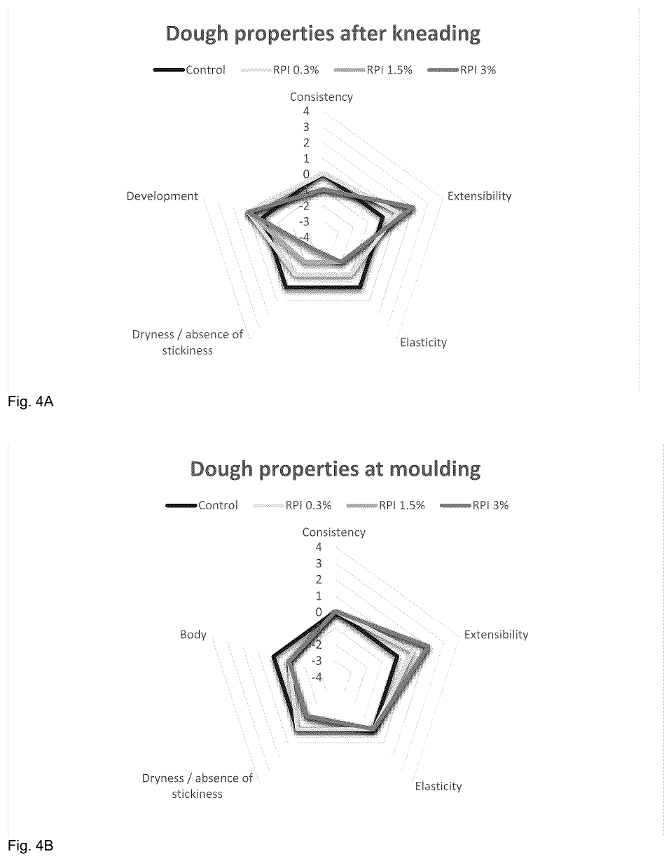

Four doughs with the relaxation ingredients according to table 5 added to the base dough (table 4) were kneaded and assessed for viscoelastic properties (see example 1) after kneading and at moulding. The results are shown in FIG. 4.

TABLE 5
Added relaxation ingredients and
applied water correction (% OFW)

| | | | | | |
|---|---|---|---|---|---|
| Ingredient | Type | 1 | 2 | 3 | 4 |

| | | | | | |
|---|---|---|---|---|---|
| RPI | DSM | % OFW | 0.3 | 1.5 | 3 |

| | | | |
|---|---|---|---|
| Water correction | % OFW | −2.3 | −4.8 |

FIG. 4A shows a dose response of RPI and shows that rapeseed protein isolate increased extensibility, development and stickiness and decreased elasticity and consistency after kneading FIG. 4B shows that at moulding, RPI increased extensibility, stickiness and decreased body.

Table 6 shows that addition of rapeseed protein isolate (RPI) gave an increased volume to the loaves of bread obtained after baking, as compared to the control. The numbers are the averages of two loaves.

TABLE 6
Relative loaf volumes whole meal breads

| Relaxation ingredient | Relative |
|---|---|
| used (% OFW) | Volume (%) ²⁰ |
| Control | 100 |
| RPI 1.5% | 102 |

### Example 3

### Preparation of Wheat Tortilla

Doughs were prepared using the ingredients of table 7.

TABLE 7
Wheat tortilla dough composition

| | | % on flour | |
|---|---|---|---|
| Ingredient | grams | weight | Type |
| Wheat flour | 2000 | | Kolibri (11.5% protein), |
| | | | Dossche Mills, |
| | | | the Netherlands |
| Water | 1025 | 51 | Tapwater |
| Salt | 30 | 1.5 | Suprasel, Akzo Nobel, the |
| | | | Netherlands |
| Sodium bicarbonate | 16 | 0.8 | Broer, the Netherlands |
| SAPP 28 | 28 | 1.4 | Levall 28 AR, Budenheim |
| Bakers fat | 180 | 9 | Trio pure soft, CSM |
| Dextrose | 40 | 2 | Tereos Syral, Belgium |
| Mono- diglycerides | 6 | 0.3 | Lamemul ® K 2000K, |
| | | | BASF |
| Fumaric acid | 7 | 0.4 | Merck |
| Calcium propionate | 10 | 0.5 | Kemira, the Netherlands |
| Potassium sorbate | 5 | 0.25 | Brenntag, the Netherlands |
| BakeZyme ® P500 | 0.01 | 0.0005 | fungal alpha-amylase from |
| | | | DSM, The Netherlands |
| BakeZyme ® | 0.02 | 0.001 | fungal hemicellulase from |
| HSP6000 | | | DSM, The Netherlands |

The dough was made in a Diosna SP-12 kneader with settings 1^{st} speed 2 minutes, 2^{nd} speed 7 minutes and had a dough temperature of 30° C. (+/−0.5° C.). The dough was assessed on viscoelastic properties and rested in a Wachtel Octopus proof cabinet for 5 minutes at 30° C. with a relative humidity of 88%. Then the dough was divided and rounded with a WP Haton Rotamat in pieces of 52 g and rested in a Wachtel Octopus proof cabinet for 8 minutes at 30° C. with a relative humidity of 88%. The dough balls were pressed with a Cuppone Pizzaform for 2.5 seconds on 150° C. top and floor heat. The diameter after the press was aimed to be 20 cm (+/−1 cm). The flattened doughs were placed in a Wachtel Piccolo deck oven set at 130° C. top heat and 230° C. floor heat and baked on each side for 35 seconds.

After baking, the tortillas were cooled for at least 10 minutes to 40° C. (+/−2° C.), before being packed in plastic bags. After 1 week the tortillas were assessed on diameter, shape, softness, rollability and stickiness.

The control refers to a tortilla prepared from the ingredients in Table7, i.e. to which no dough relaxer was added.

### Results

Four doughs with the relaxation ingredients according to table 8 added to the base dough (table 7) were kneaded and assessed for viscoelastic properties after kneading and at pressing manually and visually by experienced bakers.

TABLE 8
Added relaxation ingredients and
applied water correction (% OFW)

| | | | | | |
|---|---|---|---|---|---|
| Ingredient | Type | 1 | 2 | 3 | 4 |

| | | | | | |
|---|---|---|---|---|---|
| RPI | DSM | % OFW | 0.3 | 1 | 3 |

| | | | |
|---|---|---|---|
| Water correction | % OFW | −2.3 | −4.8 |

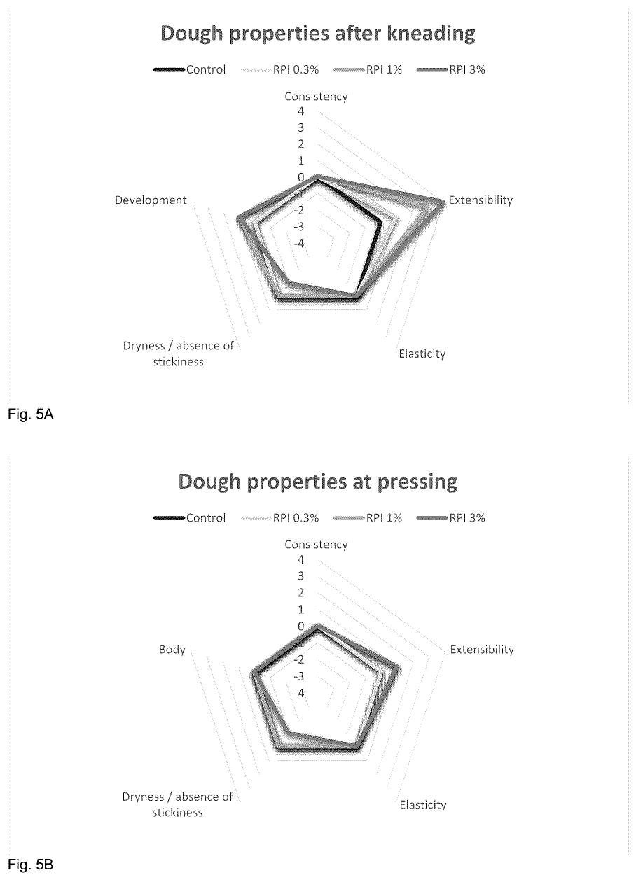

The results are shown in FIG. 5. FIG. 5A shows that rapeseed protein isolate (RPI) increased extensibility, dough development and stickiness after kneading. FIG. 5B shows that rapeseed protein increased extensibility and stickiness at pressing.

### Example 4

### Preparation of White Batard Wheat Flour 1

Doughs were prepared using the ingredients of table 9.

TABLE 9
White batard wheat flour 1 dough composition

| | | % on flour | |
|---|---|---|---|
| Ingredient | grams | weight | Type |
| Wheat flour | 3000 | | Kolibri (11.5% protein), |
| | | | Dossche Mills, |
| | | | the Netherlands |
| Water | 1855 | 62 | Tapwater |
| Salt | 54 | 1.8 | Suprasel, Akzo Nobel, |
| | | | the Netherlands |
| Yeast) | 60 | 2.0 | Koningsgist, AB Mauri, |
| | | | the Netherlands |
| Flour corrector 3 | 15 | 0.5 | Custom blend (see below) |
| Panamore ® | 0.015 | 0.0005 | Fungal phospholipase, |
| Golden | | | DSM, the Netherlands |

The flour corrector 3 was a composition comprising 30 ppm ascorbic acid (from DSM Nutritional Products, Switzerland), 2 ppm Bakezyme® P500 (fungal alpha-amylase from DSM, The Netherlands), 15 ppm Bakezyme® HSP6000 (fungal hemicellulase from DSM, The Netherlands) and Kolibri flour from (Dossche Mills, the Netherlands) as carrier material.

The dough was made in a Diosna SP-12 kneader with settings 1^{st} speed 400 revolutions, 2^{nd} speed 1560 revolutions and had a dough temperature of 27° C. (+/−0.5° C.). The dough was assessed on viscoelastic properties. Then the dough was rested for 10 minutes and divided in pieces of 350 g. The dough was rounded and proofed in the bench proof cabinet for 20 minutes at 28° C. and 90% relative humidity. Then, the dough pieces were moulded using a Bertrand moulder and placed on greased baking trays and the viscoelastic properties assessed. After that, the dough pieces were proofed in a Wachtel Octopus proof cabinet for 90 minutes and 120 minutes at 32° C. with a relative humidity of 88%. And for 150 minutes at 30° C. with a relative humidity of 88%. The fully proofed dough pieces were cut once, vertically on top of the dough piece, using a razor blade knife and placed in a Wachtel Piccolo deck oven set at 245° C. top heat and 235° C. floor heat with initial steam addition and baked for 5 minutes. After that, the temperature was decreased to 225° C. top heat and 235° C. floor heat for another 20 minutes.

After baking, the oven was unloaded, the breads were taken of the baking trays and placed on a rack to cool for at least one hour at ambient temperature, which was typically between 20 and 25° C. After 1-2 hours cooling, the breads were assessed on volume, shape, softness and structure.

After cooling down to room temperature, the volumes of the batards were determined by an automated bread volume analyser (BVM-LC, TexVol Instruments). The volume of the control batard is defined as 100%.

### Results

Two doughs with the relaxation ingredients according to table 10 added to the base dough (table 9) were kneaded and assessed for viscoelastic properties by experienced bakers after kneading and at moulding. Control refers to a batard to which no dough relaxer was added.

TABLE 10
Added relaxation ingredients (% OFW)

| Ingredient | Type | | 1 | 2 |
|---|---|---|---|---|
| RPI | DSM | % OFW | | 0.75 |

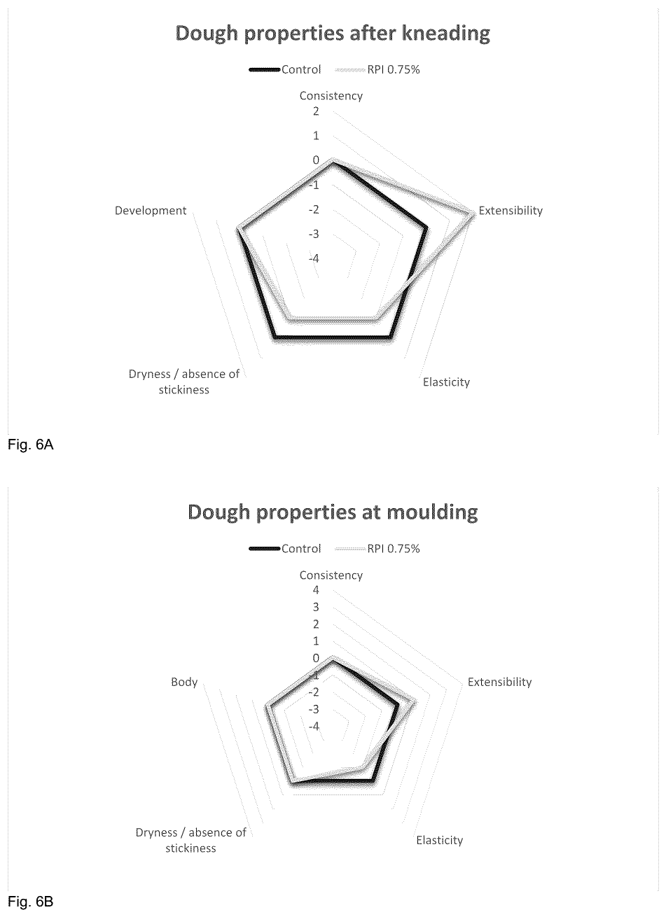

The results are shown in FIG. 6. FIG. 6A shows that rapeseed protein isolate increased extensibility and stickiness and gave less elasticity compared to the control at kneading. FIG. 5B shows that at moulding, rapeseed protein isolate increased extensibility and decreased elasticity compared to the control.

The average volume of two batards is shown in table 11, showing that adding rapeseed protein increased the volume.

TABLE 11
Relative loaf volumes white batard wheat flour 1

| | Relative | Relative | Relative |
|---|---|---|---|
| | volume (%) | volume (%) | volume (%) |
| Proofing time | 90 minutes | 120 minutes | 150 minutes |
| Control | 100 | 115 | 127 |
| RPI 0.75% | 103 | 119 | 135 |

### Preparation of White Batard Wheat Flour 2

Doughs were prepared using the ingredients of table 12.

TABLE 12
White batard wheat flour 2 dough composition

| | | % on | |
|---|---|---|---|
| Ingredient | grams | flour weight | Type |
| Wheat flour | 3000 | | Ibis (15% protein), Dossche |
| | | | Mills, the Netherlands |
| Water | 1865 | 63 | Tapwater |
| Salt | 54 | 1.8 | Suprasel, Akzo Nobel, the |
| | | | Netherlands |
| Yeast | 60 | 2.0 | Koningsgist, AB Mauri, the |
| | | | Netherlands |
| Flour corrector 3 | 15 | 0.5 | Custom blend (see below) |
| Panamore ® | 0.015 | 0.0005 | Fungal phospholipase, |
| Golden | | | DSM, the Netherlands |

Three doughs with the relaxation ingredients as in table 13, added to the base dough (table 12) were kneaded and assessed for viscoelastic properties after kneading and at moulding by experienced bakers.

TABLE 13
Added relaxation ingredients (% OFW)

| Ingredient | Type | | 1 | 2 |
|---|---|---|---|---|
| RPI | DSM | % OFW | | 0.75 |

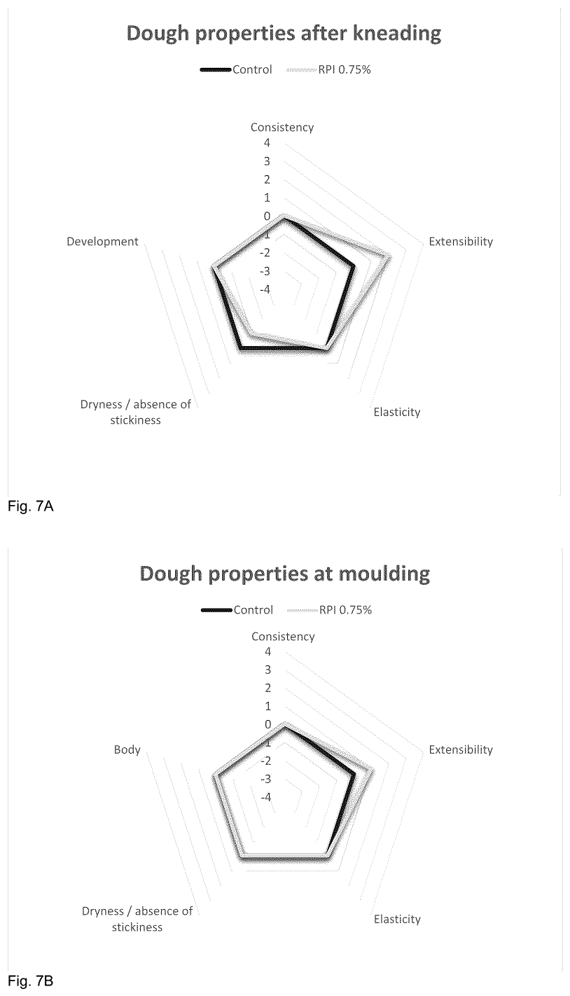

The results are shown in FIG. 7. FIG. 7A shows that rapeseed protein isolate increased extensibility and stickiness compared to the control at kneading. FIG. 7B shows that at moulding, rapeseed protein isolate gave some more extensibility.

Table 14 shows the volumes of the batards, wherein the volumes are averages to two batards. The batard increased in volume when adding rapeseed protein isolate in the dough. With 150 minutes of proofing time, the control lost stability compared to 90 and 120 minutes with this flour. The bater with added rapeseed protein isolate (RPI) increased the volume with 150 minutes of proofing as well.

TABLE 14
Relative loaf volumes white batard wheat flour 2

| | Relative | Relative | Relative |
|---|---|---|---|
| | volume (%) | volume (%) | volume (%) |
| Proofing time | 90 minutes | 120 minutes | 150 minutes |
| Control | 100 | 112 | 91 |
| RPI 0.75% | 114 | 125 | 119 |

### Example 5

### Preparation of Pizza Base

Doughs were prepared using the ingredients of table 15.

TABLE 15
Pizza base dough composition

| | | % on flour | |
|---|---|---|---|
| Ingredient | grams | weight | Type |
| Wheat flour | 900 | | Kolibri (11.5% protein), Dossche |
| | | | Mills, the Netherlands |
| Wheat flour | 600 | | Ibis (15% protein), Dossche |
| | | | Mills, the Netherlands |
| Whole wheat | 1500 | | Acacia (14.5% protein), Dossche |
| flour | | | Mills, the Netherlands |
| Water | 1745 | 60 | Tapwater |
| Salt | 54 | 1.8 | Suprasel, Akzo Nobel, the |
| | | | Netherlands |
| Yeast | 60 | 2.0 | Koningsgist, AB Mauri, the |
| (Koningsgist) | | | Netherlands |
| Sugar | 90 | 3.0 | Suikerunie, the Netherlands |
| Rapeseed oil | 87 | 2.9 | Aldoc BV, the Netherlands |
| Ascorbic acid | 0.06 | 0.002 | DSM Nutritional Products, |
| | | | Switzerland |
| BakeZyme ® | 0.015 | 0.0005 | fungal alpha-amylase from |
| P500 | | | DSM, The Netherlands |
| BakeZyme ® | 0.09 | 0.003 | fungal hemicellulase from |
| FXP1500 | | | DSM, The Netherlands |

The dough was made in a Diosna SP-12 kneader with settings 1^{st} speed 3 minutes, oil added in and kneaded for 1 minute, then 2^{nd} speed for 8 minutes. The dough had a dough temperature of 23° C. (+/−0.500). The dough was assessed on viscoelastic properties. Then the dough was left to rest at room temperature for 10 minutes. Then the dough was divided in pieces of 215 g, rounded and proofed in the Wachtel Octopus proof cabinet for 90 minutes at 38° C. and 88% relative humidity. Then, the dough pieces were moulded and topped by hand and placed on greased baking trays. The trays were placed in a Wachtel Piccolo deck oven set at 220° C. top heat and 200° floor heat with initial steam addition and baked for 9 minutes.

### Results

To test the effect of adding rapeseed protein isolate, the doughs of table 16 were made.

TABLE 16
Added relaxation ingredients (% OFW)

| Ingredient | Type | | 1 | 2 |
|---|---|---|---|---|
| RPI | DSM | % OFW | | 3 |

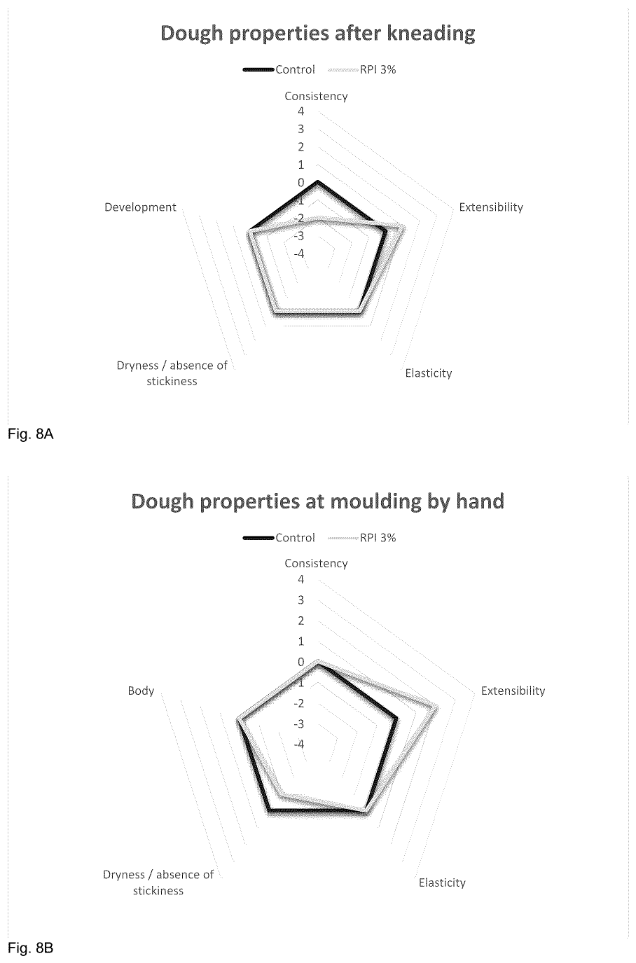

The results are shown in FIG. 8. FIG. 8A shows that adding 3% rapeseed protein isolate increased extensibility and reduced the consistency of the dough, showing increased relaxation of the dough after kneading. FIG. 8B shows that at moulding by hand the dough with rapeseed protein isolates gave increased extensibility compared to the control.

### Example 6

### Wheat Flour Alveograph Results

A dough was prepared of flour and water and adding rapeseed protein isolate as % of flour weight. The effect of rapeseed protein isolate on dough properties on Kolibri flour (11.5% protein) and Ibis flour (15% protein) was measured on a Chopin alveograph, used according to the manufacturer's instructions. P (tenacity), L (extensibility) and P/L were the alveograph properties that were measured. The results are shown in table 17 and 18.

TABLE 17
Alveograph analyses of wheat flour

| | Water | P | | |
|---|---|---|---|---|
| | % | (mmH2O) | L (mm) | P/L |
| Wheat flour 1 (Kolibri) | 58.0 | 60 | 45 | 1.39 |
| Kolibri + RPI 0.1% | 58.2 | 57 | 59 | 1.01 |
| Kolibri + RPI 0.3% | 58.2 | 54 | 52 | 1.04 |
| Kolibri + RPI 0.6% | 58.4 | 50 | 60 | 0.85 |
| Kolibri + RPI 1.5% | 59.0 | 42 | 68 | 0.62 |

TABLE 18

| | | P | | |
|---|---|---|---|---|
| | % | (mmH2O) | L (mm) | P/L |
| Wheat flour 2 (Ibis) | 60.1 | 50 | 70 | 0.72 |
| Ibis + RPI 0.3% | 60.5 | 48 | 72 | 0.68 |
| Ibis + RPI 1.5% | 61.9 | 43 | 75 | 0.57 |

Adding rapeseed protein isolate increased the L-value, decreased the P-value and decreased the P/L-value, showing an increase in extensibility (L) a decrease in dough resistance to deformation (P). The effect of RPI was larger on Kolibri flour than on Ibis flour, indicating that a lower level of RPI was sufficient to give relaxation and extensibility to a wheat flour with a lower protein content than a wheat flour with a higher level of protein.

### Example 7

Preparation of White Tin Breads with Different Canola Proteins

White tin breads were prepared using the recipe and method of example 1. The following relaxation agent was used at a level of 1.5% (of flour weight).

TABLE 19

| Sample | Relaxation agent |
|---|---|
| 1 | Control without relaxation agent |
| 2 | Rapeseed protein isolate (RPI) according to |
| | WO2018/007492 having 40 to 65 wt. % |
| | cruciferins and 35 to 60 wt. % napins |
| 3 | Puratein ® HS (mainly napins), from Merit |
| | Functional Foods, Canada |
| 4 | Puratein ® G (mainly cruciferins), from Merit |
| | Functional Foods, Canada |

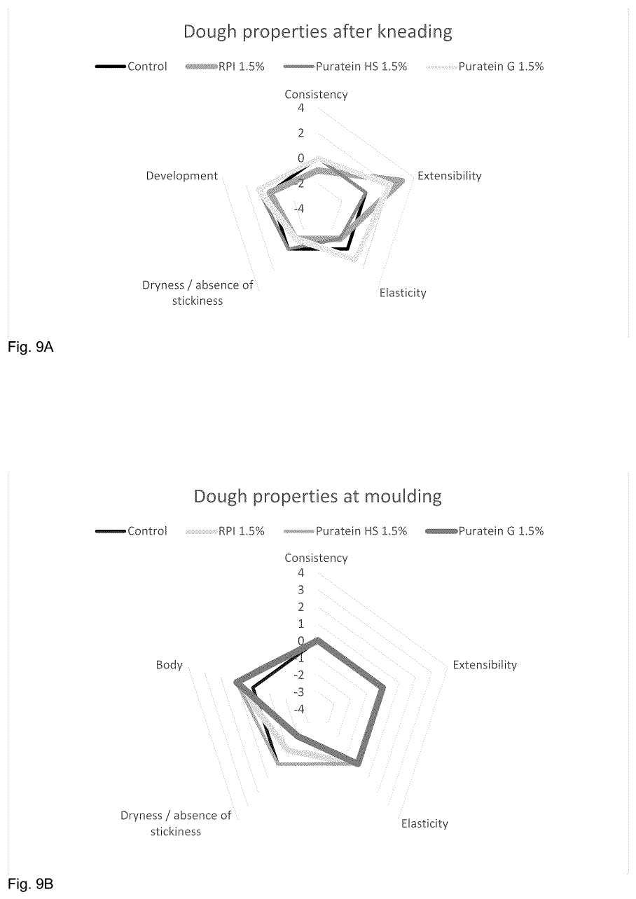

The results are shown in FIGS. 9A and B. FIG. 9A shows that specifically RPI and Puratein® G increase the extensibilty of the dough after kneading. FIG. 9B shows that specifically RPI and Puratein® G decrease the dryness of the dough at moulding.

Subsequently, loaf volume were analyzed. A drop test was performed as follows. Dough was prepared from batches of 3 kg flour, to form at least 4×840 g dough pieces after moulding which were placed in appropriate baking-tins (320×105×85 mm). After proofing, at least 2 doughs in their respective tins were subjected to a drop test. One tin containing proofed dough was placed on top of two empty tins of the same size placed upside down on the workbench. The two empty tins were taken apart by hand with one quick move causing the dough containing tin to drop on the workbench. At least 2 dough pieces in tins were not subjected to any drop-treatment. All dough pieces, with and without drop-treatment were baked. After baking, the specific volume of breads made from the doughs subjected to ‘no drop’ and ‘drop’, was established using the laser volumeter from Tex Vol instrument (Perten).

Table 20 below shows that RPI and Puratein® G provide a slightly increased loaf volume.

TABLE 20

| Relaxation | | Relative volume |
|---|---|---|
| ingredient used | Relative | after drop test |
| (% OFW) | Volume (%) | (%) |
| Control | 100 | 98 |
| RPI 1.5% | 102 | 97 |
| Puratein ® HS 1.5% | 100 | 92 |
| Puratein ® G 1.5% | 102 | 100 |

1. A cereal flour-based dough comprising at least 50 wt. % cereal flour, based on the dry weight of the cereal flour-based dough, and rapeseed protein, wherein said rapeseed protein is present in an amount between 0.01 and 15 wt. %, based on the weight of the cereal flour in the cereal flour-based dough, wherein the cereal flour has a gluten content of 5-20 wt. %.

2. A cereal flour-based dough according to claim 1, wherein the rapeseed protein does not comprise 0 to 20 wt. % cruciferins and 80 to 100 wt. % napins.

3. A cereal flour-based dough according to claim 1, wherein the cereal is chosen from the group consisting of corn, rice, wheat, barley, sorghum, millet, oats, rye, triticale, buckwheat, quinoa, spelt, einkorn, emmer, durum and kamut.

4. A cereal flour-based dough according to claim 1, further comprising yeast, sodium bicarbonate and/or salt.

5. A cereal flour-based dough according to claim 1, further comprising water, optionally in an amount between 20 to 75 wt. % based on the weight of the cereal flour in the cereal flour-based dough.

6. A cereal flour-based dough according to claim 1, wherein the cereal flour has a gluten content 9 to 16 wt. %, optionally 13 to 16 wt. %, of the cereal flour.

7. A cereal flour-based dough according to claim 1, wherein the cereal flour is a wheat flour, optionally a wheat flour chosen from the group consisting of white flour, whole wheat flour, Graham flour, instant flour, whole wheat white flour, all-purpose flour and enriched flour.

8. A cereal flour-based dough according to claim 1, wherein the dough is a bread dough, tortilla dough, pizza dough, chapati dough, pita dough, lafa dough, lavash dough, matzah dough, naan dough, roti dough, sangarak dough, cracker dough, wafer dough, pastry dough, croissant dough, brioche dough, panettone dough, pasta dough, noodles dough, taco dough, cookie dough, bagel dough, pie crust dough, steam bread dough, brownie batter or sheet cake batter.

9. A cereal flour-based dough according to claim 1, wherein the rapeseed protein comprises 40 to 65 wt. % cruciferins and 35 to 60 wt. % napins.

10. A cereal flour-based dough according to claim 1, wherein the rapeseed protein comprises 60 to 80 wt. % cruciferins and 20 to 40 wt. % napins.

11. A cereal flour-based dough according to claim 1, wherein the rapeseed protein comprises 0 to 20 wt. % cruciferins and 80 to 100 wt. % napins.

12. A method for producing a cereal flour-based dough as defined in claim 1, comprising blending water, a cereal flour and rapeseed protein to form the cereal-flour based dough.

13. Bread improver composition comprising from 1 to 80 wt. % rapeseed protein and a compound selected from an enzyme, an emulsifier, ascorbic acid and flour.

14. A baked product comprising at least 50 wt. % cereal flour and 0.01 and 15 wt. % rapeseed protein, based on the dry weight of the baked product.

15. A product comprising a rapeseed protein as a cereal flour based dough of claim 1 as a relaxation aid.
